(19) United States
(12) Patent Application Publication
(10) Pub. No.: US 2026/0189445 A1
(43) Pub. Date: Jul. 2, 2026

(54) ULTRA HIGH RELIABILITY RECEIVE PROCEDURES

(71) Applicant: QUALCOMM Incorporated, San Diego, CA (US)

(72) Inventors: Lin YANG, San Diego, CA (US); Bin TIAN, San Diego, CA (US); Youhan KIM, Saratoga, CA (US)

(21) Appl. No.: 19/008,353

(22) Filed: Jan. 2, 2025

(51) Int. Cl. H04L 27/26; H04B 17/318; H04B 17/345; H04L 5/00

(52) U.S. Cl. CPC H04L 27/26136; H04B 17/345; H04L 5/0048; H04B 17/318; H04L 27/26035

(57) ABSTRACT

This disclosure provides methods, components, devices and systems for ultra-high reliability (UHR) receive procedures. Some aspects more specifically relate to determining whether to perform an ELR mark check procedure on a physical layer protocol data unit (PPDU). In some examples, a wireless device may receive a preamble portion of a PPDU. The wireless device may process one or more fields of the preamble portion to determine to check whether the PPDU is associated with the ELR format and if the deferral is based on length in ELR signaling or based on the non-ELR processing rules. For example, the wireless device may perform an ELR mark detection procedure on a candidate ELR field based on a sequence of a basic service set color and a determination to check whether the PPDU is associated with the ELR format.

### TECHNICAL FIELD PAR

This disclosure relates generally to wireless communication and, more specifically, to ultra-high reliability extended long range receive procedures.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

A method for wireless communications by a wireless device is described. The method may include receiving a preamble portion of a physical layer protocol data unit (PPDU) including a set of multiple fields, where the wireless device is associated with a basic service set and a sequence that indicates a basic service set color of the basic service set, processing one or more fields of the set of multiple fields of the preamble portion to determine to check whether the PPDU is associated with an enhanced long range (ELR) format, parsing a universal signal (U-SIG) field of the set of multiple fields or performing an ELR mark detection procedure on a candidate ELR field of the set of multiple fields based on the sequence of the basic service set color and on a determination to check whether the PPDU is associated with the ELR format, and performing an ELR preamble parsing procedure or entering another PPDU parsing mode based on the ELR mark detection procedure or parsing the U-SIG field of the set of multiple fields, or both.

A wireless device for wireless communications is described. The wireless device may include a processing system that includes processor circuitry and memory circuitry that stores code. The processing system may be configured to cause the wireless device to receive a preamble portion of a PPDU including a set of multiple fields, where the wireless device is associated with a basic service set and a sequence that indicates a basic service set color of the basic service set, process one or more fields of the set of multiple fields of the preamble portion to determine to check whether the PPDU is associated with an ELR format, parse a U-SIG field of the set of multiple fields or perform an ELR mark detection procedure on a candidate ELR field of the set of multiple fields based on the sequence of the basic service set color and on a determination to check whether the PPDU is associated with the ELR format, and perform an ELR preamble parsing procedure or entering another PPDU parsing mode based on the ELR mark detection procedure or parsing the U-SIG field of the set of multiple fields, or both.

Another wireless device for wireless communications is described. The wireless device may include means for receiving a preamble portion of a PPDU including a set of multiple fields, where the wireless device is associated with a basic service set and a sequence that indicates a basic service set color of the basic service set, means for processing one or more fields of the set of multiple fields of the preamble portion to determine to check whether the PPDU is associated with an ELR format, means for parsing a U-SIG field of the set of multiple fields or means for performing an ELR mark detection procedure on a candidate ELR field of the set of multiple fields based on the sequence of the basic service set color and on a determination to check whether the PPDU is associated with the ELR format, and means for performing an ELR preamble parsing procedure or entering another PPDU parsing mode based on the ELR mark detection procedure or parsing the U-SIG field of the set of multiple fields, or both.

A non-transitory computer-readable medium storing code for wireless communications is described. The code may include instructions executable by one or more processors to receive a preamble portion of a PPDU including a set of multiple fields, where the wireless device is associated with a basic service set and a sequence that indicates a basic service set color of the basic service set, process one or more fields of the set of multiple fields of the preamble portion to determine to check whether the PPDU is associated with an ELR format, parse a U-SIG field of the set of multiple fields or perform an ELR mark detection procedure on a candidate ELR field of the set of multiple fields based on the sequence of the basic service set color and on a determination to check whether the PPDU is associated with the ELR format, and perform an ELR preamble parsing procedure or entering another PPDU parsing mode based on the ELR mark detection procedure or parsing the U-SIG field of the set of multiple fields, or both.

Some examples of the method, wireless devices, and non-transitory computer-readable medium described herein may further include operations, features, means, or instructions for processing the U-SIG field that indicates that the PPDU may be associated with the ELR format, where performing the ELR preamble parsing procedure may be based on the U-SIG subfield that indicates the PPDU may be associated with the ELR format.

In some examples of the method, wireless devices, and non-transitory computer-readable medium described herein, processing the one or more fields may include operations, features, means, or instructions for performing one or more error detection procedures for a legacy signal (L-SIG) field, a high throughput signal (HT-SIG) field, a very high throughput signal (VHT-SIG) field, a high efficiency signal (HE-SIG) field, or the U-SIG field, or any combination thereof, where performing the ELR mark detection procedure may be based on one or more failures of the one or more error detection procedures.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a format detection procedure that supports ultra-high reliability (UHR) receive procedures.

FIG. 6 shows an example of a format detection procedure that supports UHR receive procedures.

FIG. 7 shows an example of a data processing procedure that supports UHR receive procedures.

FIG. 8 shows an example of a UHR preamble parsing procedure that supports UHR receive procedures.

FIG. 9 shows an example of an ELR processing procedure that supports UHR receive procedures.

FIG. 10 shows an example of a receive terminating procedure that supports UHR receive procedures.

FIG. 11 shows an example of a process flow that supports UHR receive procedures.

FIG. 12 shows a block diagram of an example wireless communication device that supports UHR receive procedures.

FIG. 13 shows a flowchart illustrating an example process performable by or at a wireless device that supports UHR receive procedures.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, an enhanced long range (ELR) physical layer protocol data unit (PPDU) may be communicated between a wireless station (STA) and an access point (AP). The ELR PPDU may enable communications over a relatively longer range. A receiving wireless device which is capable of ELR communications may check an ELR mark field for an ELR mark symbol to determine that the PPDU is of the ELR format and intended for the receiver. In some examples, an intended receiver of the ELR PPDU may be unable to parse contents of other fields, such as a legacy signal (L-SIG) field, a repeated legacy signal (RL-SIG) field, and a universal signal (U-SIG) field. For example, information in these fields may become distorted when the PPDU is transmitted over longer distances. For PPDUs of other formats, a receiver may parse through these fields to determine a PPDU format for the PPDU. However, as these fields may become distorted when transmitted over a long distance, and the ELR PPDU may be used for longer-distance communications, an intended receiver may, in some cases, be unable to determine whether a PPDU is of the ELR PPDU format based on these fields.

Various aspects relate generally to a receive procedure at a wireless device. Some aspects more specifically relate to a receive procedure at a wireless device to determine whether to perform an ELR mark detection procedure for a PPDU to check for an ELR mark. A wireless device may receive a PPDU, and the wireless device may determine whether to perform an ELR mark detection procedure for the PPDU. In some examples, a universal signal (U-SIG) field of the PPDU may indicate that the PPDU is of the ELR PPDU format by a PPDU type subfield. In some examples, ELR validate bits in the U-SIG field may further verify that the PPDU is of the ELR PPDU format. The receive device may perform the ELR preamble parsing based on the U-SIG field of the PPDU. In some examples, a cyclic redundancy check (CRC) may fail when receiving a legacy signal (L-SIG) field, a high throughput (HT) signal (HT-SIG) field, a very high throughput (VHT) signal (VHT-SIG) field, a high efficiency (HE) signal (HE-SIG) field, or the U-SIG field, and the wireless device may perform the ELR mark detection procedure based on the CRC failure. In some examples, the wireless device may process, in parallel, the PPDU as a non-HT PPDU or a HE single user (SU) PPDU, and the receiving device may determine to perform the ELR mark detection procedure while parallel processing the PPDU according to a non-HT PPDU format or an HE SU PPDU format. Techniques for performing deferral are described herein. If a length subfield in an ELR signal (ELR-SIG) field of the PPDU is decoded successfully, the receiving device may defer communications according to the length parameter indicated by the ELR-SIG field. Otherwise, the receiving device may defer communications according to legacy modes'processing rules.

Particular aspects of the subject matter described in this disclosure can be implemented to realize one or more of the following potential advantages. In some examples, by determining whether to perform the ELR mark detection procedure based on the U-SIG field, CRC failure, or parallel processing, the described techniques can be used to detect whether a PPDU is of the ELR format and intended for the receiving device, of a different PPDU format, or not intended for the receiving device. By detecting the PPDU is of the ELR format and intended for the receiving device, the receiving device may be able to decode data information of the PPDU, increasing throughput. If the receiving device detects the PPDU is of a different PPDU format or not intended for the receiving device, the receiving device may terminate a UHR receive procedure, or decode data information with proper PPDU format.

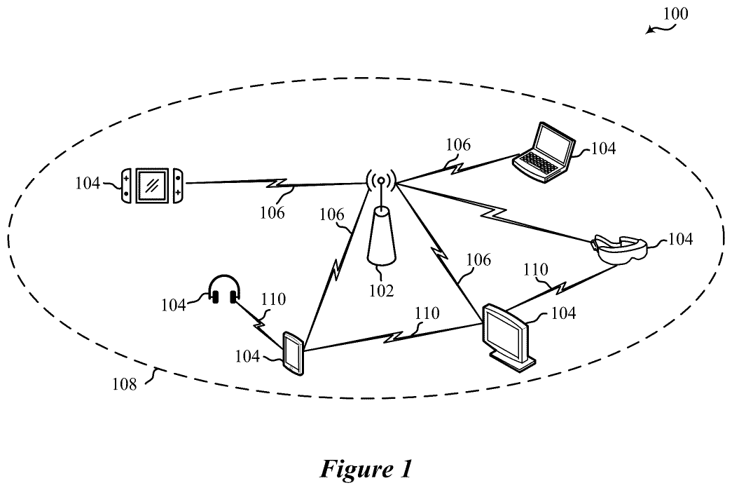

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

The wireless communications network 100 may include techniques for a UHR receive procedure. For example, a wireless device may perform the UHR receive procedure to determine whether to perform an ELR mark detection procedure for a PPDU to check for an ELR mark. A wireless device may receive a PPDU, and the wireless device may determine when to perform an ELR mark detection procedure if the wireless device is ELR capable. In some examples, a CRC or parity check may fail in a legacy preamble portion up to the U-SIG field, and the wireless device may perform the ELR mark detection procedure, or the wireless device may check for the ELR mark based on the CRC or parity check failure. For example, a CRC may fail when receiving an L-SIG field, an HT-SIG field, a VHT-SIG field, and HE-SIG field, or the U-SIG field, and the wireless device may perform the ELR mark detection procedure based on the CRC failure. In some examples, the wireless device may parallelly process 802.11a traffic and perform an ELR mark detection procedure. In some examples, the wireless device may parallelly process 802.11ax traffic, such as to process an ER SU PPDU, and perform an ELR mark detection procedure.

In some examples, a universal signal (U-SIG) field of the PPDU may indicate that the PPDU is of the ELR PPDU format. The wireless device may perform ELR preamble parsing after an ELR mark is detected based on an ELR mark detection procedure based on the U-SIG field indicating the PPDU is an ELR PPDU. The U-SIG field may indicate the PPDU is an ELR PPDU, and the wireless device may perform ELR preamble parsing, if all three ELR validate bits are set to ones, such as being set to 111, or a value of seven plus a matching station identifier. For example, if the U-SIG indicates that the PPPDU is an ELR PPDU, the wireless device may perform ELR preamble parsing.

Techniques for performing deferral are described herein. If a length parameter is indicated by an ELR-SIG field of the PPDU, the receiving device may defer communications according to the length parameter indicated by the ELR-SIG field. Otherwise, the wireless device may defer based on legacy modes'processing rules.

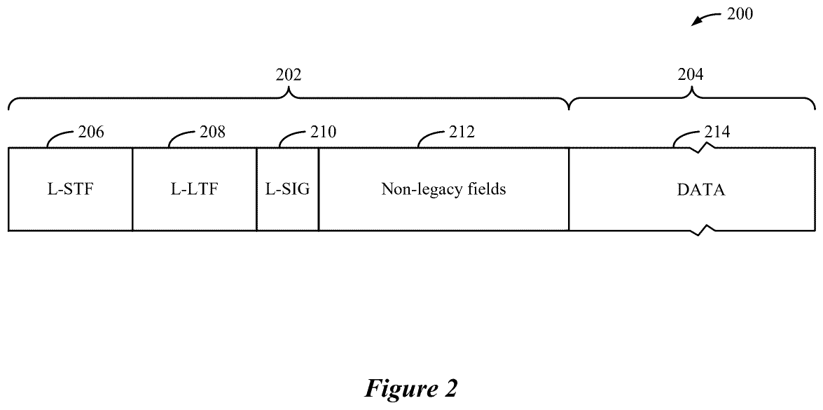

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

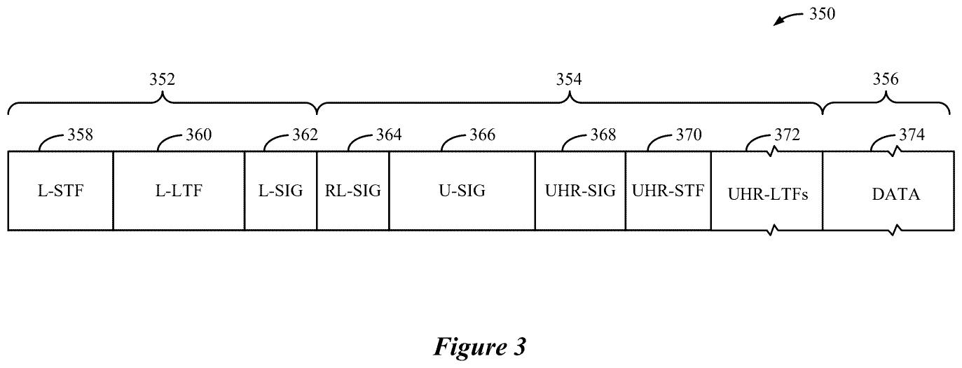

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364, a universal signal field 366 (referred to herein as “U-SIG 366”) and a UHR signal field 368 (referred to herein as “UHR-SIG 368”). The presence of RL-SIG 364 and U-SIG 366 may indicate to UHR or later version-compliant STAs 104 that the PPDU 350 is a UHR PPDU or a PPDU conforming to any later (post-UHR) version of a new wireless communication protocol conforming to a future IEEE 802.11 wireless communication protocol standard. One or both of U-SIG 366 and UHR-SIG 368 may be structured as, and carry version-dependent information for, other wireless communication protocol versions associated with amendments to the IEEE family of standards beyond UHR. For example, U-SIG 366 may be used by a receiving device (such as an AP 102 or a STA 104) to interpret bits in one or more of UHR-SIG 368 or the data field 374. U-SIG 366 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 366 and UHR-SIG 368 and additional information fields or single user (SU)-specific fields that may be useful to intended recipients. In some implementations, the version-dependent fields may include at least a PPDU format field to indicate a general PPDU format for the PPDU 350 (such as a trigger-based (TB), a single-user (SU), or a multi-user (MU) PPDU format). Like L-STF 358, L-LTF 360, and L-SIG 362, the information in U-SIG 366 and UHR-SIG 368 may be duplicated and transmitted in each of the component 20 MHz channels in instances involving the use of a bonded channel.

The non-legacy portion 354 further includes an additional short training field 370 (referred to herein as “UHR-STF 370,” although it may be structured as, and carry version-dependent information for, other wireless communication protocol versions beyond UHR) and one or more additional long training fields 372 (referred to herein as “UHR-LTFs 372,” although they may be structured as, and carry version-dependent information for, other wireless communication protocol versions beyond UHR). UHR-STF 370 may be used for timing and frequency tracking and AGC, and UHR-LTF 372 may be used for more refined channel estimation.

UHR-SIG 368 may be used by an AP 102 to identify and inform one or multiple STAs 104 that the AP 102 has scheduled uplink (UL) or downlink (DL) resources for them. UHR-SIG 368 may be decoded by each compatible STA 104 served by the AP 102. UHR-SIG 368 also may generally be used by the receiving device to interpret bits in the data field 374. For example, UHR-SIG 368 may include resource unit (RU) allocation information, spatial stream configuration information, and per-user (for example, STA-specific) signaling information. Each UHR-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some wireless communications systems, a STA 104 or an AP 102 may transmit the PPDU 350 over bandwidths larger than the 20 MHz, 40 MHz, 80 MHz, 160 MHz, and 320 MHz bandwidths supported by previous generations of IEEE-compliant wireless communication systems. For example, the PPDU 350 may support 480 MHz or 640 MHz bandwidth communications. By increasing the channel bandwidth of the PPDU 350 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 370, UHR-LTFs 372, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 366 of an ELR PPDU 350 may include a first indication (for example, a codepoint of a PHY version identifier subfield within a version-independent portion of the U-SIG 366 or a value of an ELR subfield within a version-dependent portion of the U-SIG 366) that the PPDU 350 is associated with an ELR format. The U-SIG 366 of an ELR PPDU 350 may include a second indication (for example, a STA identifier subfield within the version-dependent portion of the U-SIG 366) of an intended receiver of the PPDU. In some examples, an ELR PPDU 350 may include an ELR-signature (ELR-SIG) field that includes an uplink/downlink indicator subfield, a length subfield, a coding indicator subfield, and a modulation and coding scheme (MCS) subfield.

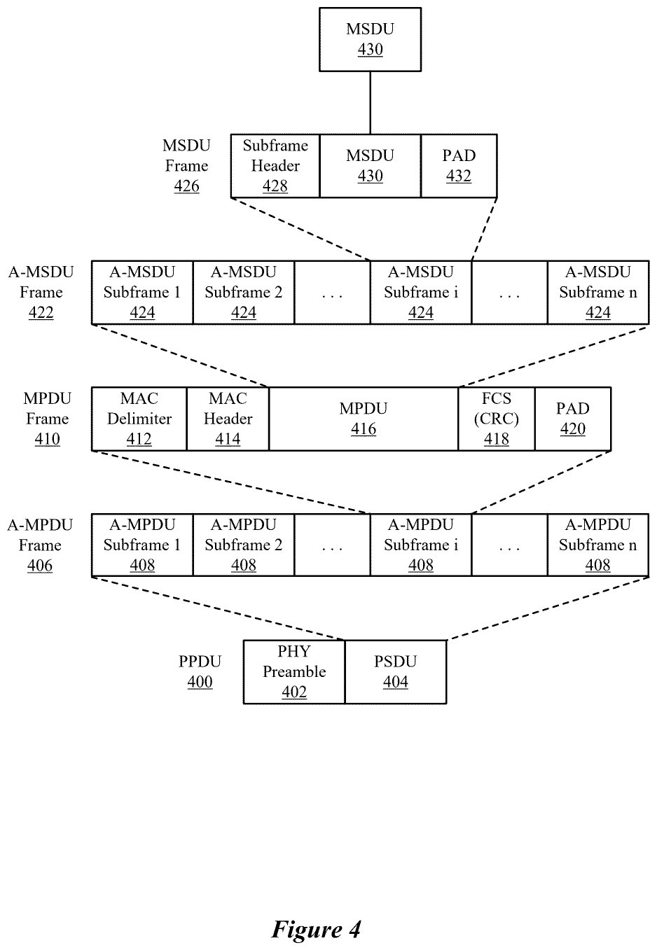

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

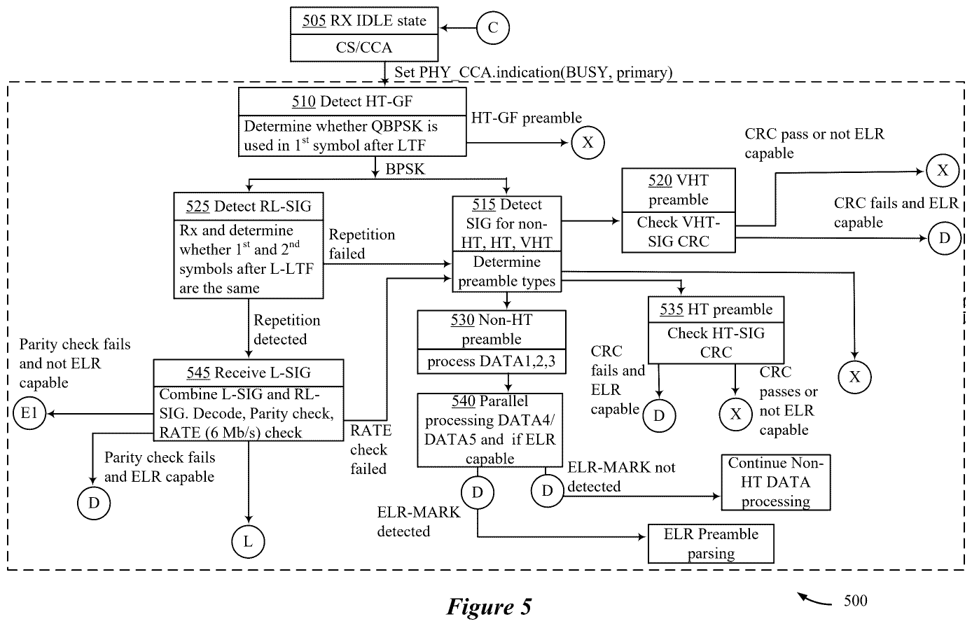

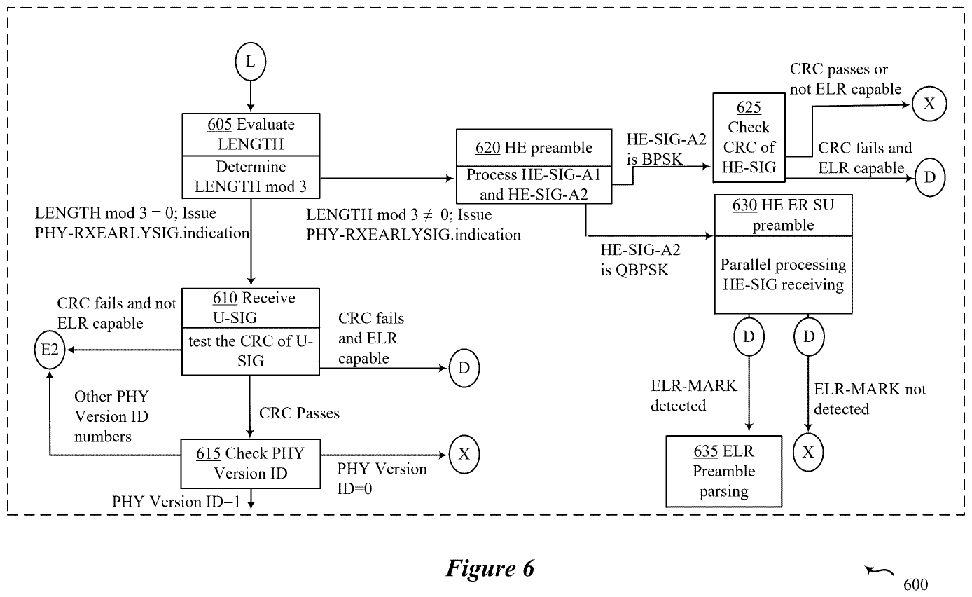

FIG. 5 shows an example of a format detection procedure 500 that supports UHR receive procedures. The format detection procedure 500 may, in some examples, be a first portion of a format detection procedure that includes a format detection procedure 600 described with reference to FIG. 6. For example, the format detection procedure 500 and the format detection procedure 600 may be included in a same format detection procedure. In some examples, a format detection procedure may be referred to as an auto detection procedure.

The format detection procedure 500 may be implemented by a receiving device. For example, the format detection procedure 500 may be a part of a UHR receive procedure at the receiving device. The receiving device may be an example of a STA 104 or an AP 102 described herein. The receiving device may receive a PPDU and perform the format detection procedure 500 and the format detection procedure 600 to determine a PPDU format of the PPDU.

Wireless device may communicate PPDUs of one or more PPDU formats. An 802.11a PPDU may include an L-STF field, an L-LTF field, an L-SIG field, and a data field. A HT greenfield (GF) PPDU may include an HT-STF field, an HT-LFT1 field, an HT-SIG1 field, an HT-SIG2 field, an HT-STF field, an HT-LTFs field, and a data field. An HT MF PPDU may include an L-STF field, an L-LTF field, an L-SIG field, an HT-SIG1 field, an HT-SIG2 field, an HT-STF field, an HT-LTFs field, and a data field. A VHT PPDU may include an L-STF field, an L-LTF field, an L-SIG field, a VHT-SIG-A1 field, a VHT-SIG-A2 field, a VHT-STF field, a VHT-STF-LTFs field, and a data field. A HE SU/TB PPDU may include an L-STF field, an L-LTF field, an L-SIG field, an RL-SIG field, an HE-SIG-A1 field, an HE-SIG-A2 field, an HE-STF field, an HE-LTFs field, and a data field. A HE multi-user (MU) PPDU may include an L-STF field, L-LTF field, an L-SIG field, an RL-SIG field, an HE-SIG-A1 field, an HE-SIG-A2 field, an HE-SIG-Bs field, an HE-STF field, an HE-LTFs field, a data field, and a packet extension. An HE ER SU PPDU may include an L-STF field, an L-LTF field, an L-SIG field, an RL-SIG field, an HE-SIG-A1 field, an HE-SIG-A2 field, an HE-SIG-A3 field, an HE-SIG-A4 field, an HE-STF field, an HE-LTFs field, a data field, and a packet extension. A WUR PPDU may include an L-STF field, an L-LTF field, an L-SIG field, a Mark1 field, a Mark2 field, and an on-off key field. An EHT MU PPDU may include an L-STF field, an L-LTF field, an L-SIG field, an RL-SIG field, a U-SIG1 field, a U-SIG2 field, an EHT-SIGs field, an EHT-STF field, an EHT-STF field, an EHT-LTFs field, a data field, and a packet extension. An EHT TB PPDU may include an L-STF field, an L-LTF field, an L-SIG field, an RL-SIG field, a U-SIG1 field, a U-SIG2 field, an EHT-STF field, an EHT-LTFs field, a data field, and a packet extension. An ER SU PPDU ay include an L-STF field, an L-LTF field, an L-SIG field, an RL-SIG field, a U-SIG1 field, a U-SIG2 field, a U-SIG3 field, and a U field. A UHR MU PPDU may include an L-STF field, an L-LTF field, an L-SIG field, an RL-SIG field, a U-SIG1 field, a U-SIG2 field, a UHR-SIGs field, a UHR-STF field, a UHR-STF field, a UHR-LTFs field, a data field, and a packet extension. A UHR TB PPDU may include an L-STF field, an L-LTF field, an L-SIG field, an RL-SIG field, a U-SIG1 field, a U-SIG2 field, a UHR-STF field, a UHR-LTFs field, a data field, and a packet extension. An ELR PPDU may include an L-STF field, an L-LTF field, an L-SIG field, an RL-SIG field, a U-SIG1 field, a U-SIG2 field, an ELR-Mark1 field, an ELR-Mark2 field, an ELR-STF field, an ELR-LTFs field, an ELR-SIG field, a data field, and a packet extension.

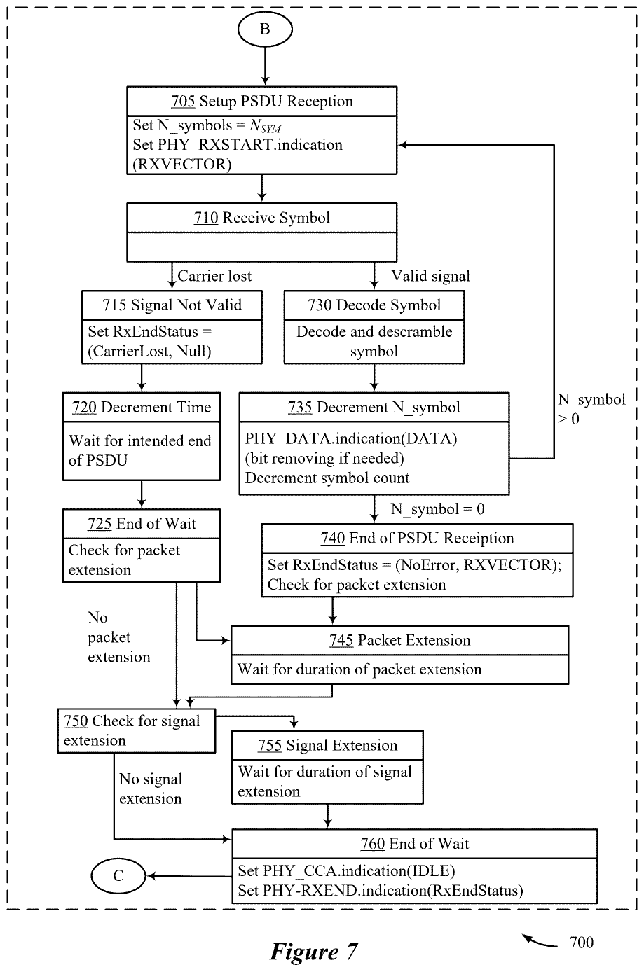

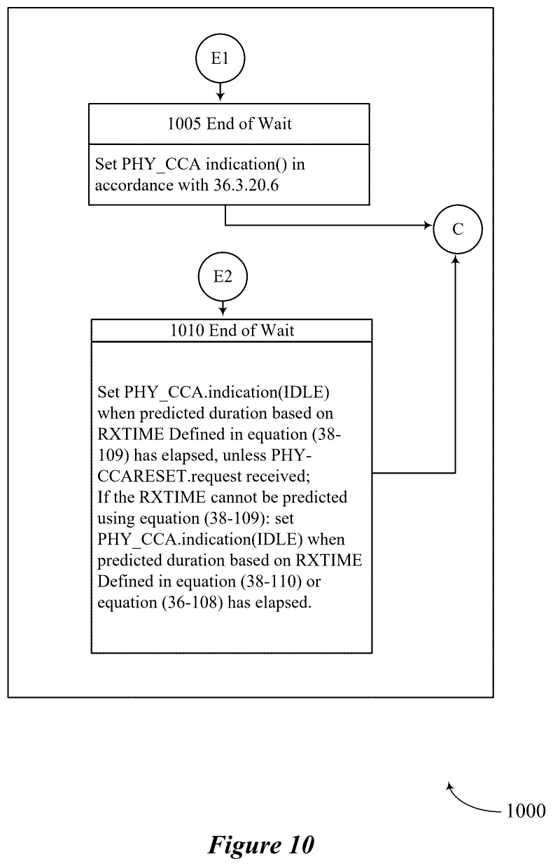

At 505, the receiving device may be operating in an RX idle state. The receiving device may perform carrier sensing or a CCA. The receiving device may perform the carrier sensing or the CCA at 505 after performing a receive terminating procedure 1000 as described with reference to FIG. 10 or a data processing procedure 700 as described with reference to FIG. 7. The receiving device may set PHY-CCA.indication(BUSY, primary).

After the PHY-CCA.indication(BUSY, channel-list) primitive is issued, a PHY entity of the receiving device may begin receiving training symbols and searching for L-SIG in to set a maximum duration of the data stream. The receiving device may search for preambles for non-HT, HT-MF, VHT, HE, EHT, UHR, and UHR ELR PPDUs (such as, if the receiving device is ELR capable). If the constellation used in the first symbol after the first long training field is QBPSK, the receiving device may continue to detect the received signal using a receive procedure for HT-GF. For detecting an EHT or UHR preamble, the receiving device may search for RL-SIG and evaluate a LENGTH field. If RL-SIG is detected, the receiving device may check the parity bit and RATE fields in L-SIG and RL-SIG. If either the check of the parity bit is invalid or the RATE field is not set to 6 Mb/s, the receiving device may issue neither a PHY-RXEARLYSIG.indication nor a PHY-RXSTART.indication primitive. If the receiving device is ELR capable, the PHY entity of the receiving device may continue to check if ELR-MARK is detected or not. If the check of the parity bit is valid and the RATE field indicates 6 Mb/s, but the LENGTH field value in L-SIG is a not a multiple of three, the receiving device may issue neither a PHY-RXEARLYSIG.indication nor a PHY-RXSTART.indication primitive. The PHY entity of the receiving device may determine from L-SIG that EHT and UHR PPDU format are excluded via other means, in which case neither a PHY-RXEARLYSIG.indication nor a PHY-RXSTART.indication primitive is issued. If the EHT and UHR preamble are not detected, the PHY entity of the receiving device may continue to detect the received signal using non-HT, HT, VHT, and HE receive procedures. In any case, if CRC fails and device is ELR capable, the PHY entity of the receiving device may continue to check if ELR-MARK is detected following the ELR processing procedure below.

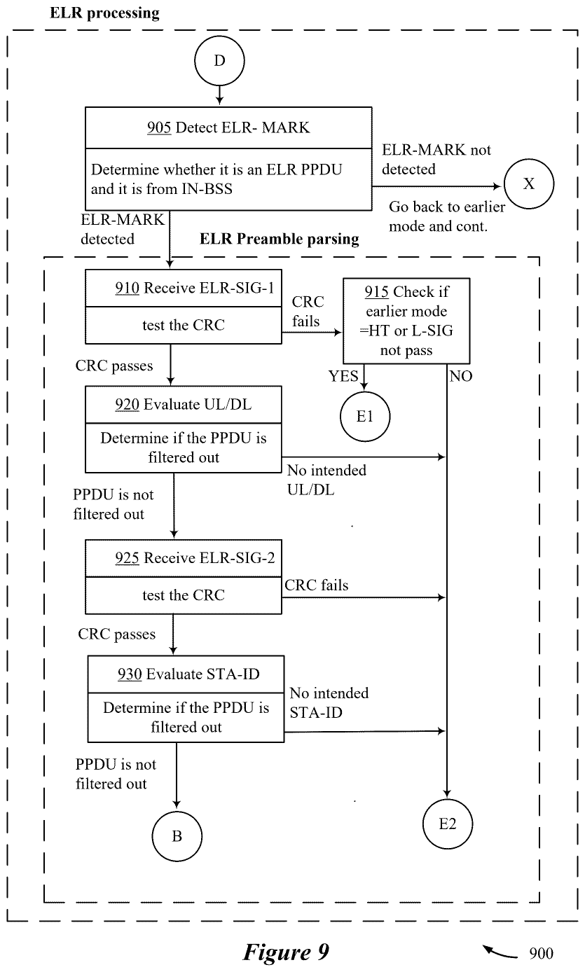

At 510, the receiving device may perform an HT greenfield (GF) detection procedure. The receiving device may determine whether a quadrature binary phase shift key (QBPSK) modulation is used in a first symbol after an LTF of the PPDU. If the receiving device detects a HT GF preamble, the receiving device may perform a HT-GF receive procedure. In some examples, if the receiving detects QBPSK in the first symbol after the LTF, the receiving device may detect a SIG field for a non-HT, HT, or VHT PPDU at 515. The receiving device may determine the preamble types. If the receiving device detects a VHT preamble at 520, the receiving device my check a VHT-SIG CRC. If the VHT-SIG CRC passes or the receiving device is not ELR capable, the receiving device may perform a different PPDU processing procedure, such as a PPDU processing procedure for a VHT PPDU. If the CRC of the VHT-SIG field fails and the receiving device is ELR-capable, the receiving device may perform an ELR processing procedure 900 as described with reference to FIG. 9.

In some examples, the receiving device may detect an RL-SIG field at 525. The receiving device may determine whether a first and second symbols after the L-LTF field are the same. If the repetition fails, or they are not the same, the receiving device may detect a SIG for non-HT, HT, or VHT PPDU formats at 515. If the receiving device detects repetition, the receiving device may receive an L-SIG at 545. The receiving device may combine the L-SIG and RL-SIG, decode, perform a parity check, and perform a rate check. If the parity check fails and the receiving device is not ELR-capable, the receiving device may perform a receive terminating procedure 1000. If the parity check fails and the receiving device is ELR-capable, the receiving device may perform an ELR processing procedure 900. For example, the receiving device may determine to perform an ELR mark detection procedure based on an L-SIG parity check failing. If the rate check and parity check pass, the receiving device may perform the format detection procedure 600 described with reference to FIG. 6. If the rate check fails, the receiving device may detect other SIGs for other formats at 515.

In some examples, the receiving device may detect a non-HT preamble at 530. The receiving device may process data fields of the PPDU. At 540, the receiving device may process, in parallel, data symbols 4 and 5 and perform the ELR processing procedure 900 if the receiving device is ELR-capable. If the receiving device does not detect an ELR mark, the receiving device may continue processing non-HT data. If the receiving device detects an ELR mark, the receiving device may perform ELR preamble parsing. For example, the PPDU may be detected as 802.11a based on an L-SIG parity check passing, no RL-SIG being detected, and no QBPSK being detected. L-SIG parity check may have a high false positive probability at a low SNR. The receiving device may parallelly check the ELR-MARK while processing 802.11a data. In some examples, the receiving device may perform the ELR processing procedure 900 as described with reference to FIG. 9 if the receiving device is ELR-capable. If the receiving device detects the ELR mark, the receiving device may perform ELR preamble parsing. If the receiving device does not detect the ELR mark, the receiving device may process non-HT data.

In some examples, the receiving device may detect an HT preamble at 535. The receiving device may check a CRC for the HT-SIG. If the CRC passes or the receiving device is not ELR capable, the receiving device may perform another PPDU parsing procedure, such as for an HT PPDU. If the CRC fails and the receiving device is ELR-capable, the receiving device may perform the ELR processing procedure 900 as described with reference to FIG. 9. For example, the PPDU may be detected as 802.11n traffic, but a CRC of the HT-SIG field may fail, and the receiving device may perform the ELR processing procedure 900 as described with reference to FIG. 9.

FIG. 6 shows an example of a format detection procedure 600 that supports UHR receive procedures. The format detection procedure 600 may, in some examples, be a second portion of a format detection procedure that includes a format detection procedure 500 described with reference to FIG. 5. For example, the format detection procedure 500 and the format detection procedure 600 may be included in a same format detection procedure. In some examples, a format detection procedure may be referred to as an auto detection procedure.

The format detection procedure 600 may be implemented by a receiving device. For example, the format detection procedure 600 may be a part of a UHR receive procedure at the receiving device. The receiving device may be an example of a STA 104 or an AP 102 described herein. The receiving device may receive a PPDU and perform the format detection procedure 500 and the format detection procedure 600 to determine a PPDU format of the PPDU.

In some examples, the receiving device may perform the format detection procedure 600 after performing operation 545 of the format detection procedure 500. For example, if a rate check and a parity check both pass after the receiving device detects an RL-SIG field and an L-SIG field, the receiving device may perform operation 605 of the format detection procedure 600.

At 605, the receiving device may evaluate a LENGTH parameter. In some examples, the receiving device may determine a value of the LENGTH parameter modulo 3. In some examples, the LENGTH parameter modulo 3 may be equal to zero. The receiving device may issue PHY-RXEARLYSIG.indication. At 610, the receiving device may receive a U-SIG field. The receiving device may test a CRC of the U-SIG field. If the CRC fails and the receiving device is ELR-capable, the receiving device may perform an ELR processing procedure 900 as described with reference to FIG. 9. For example, if the receiving device is ELR capable, the PHY entity of the receiving device may continue to check if an ELR mark is detected following an ELR processing procedure. If the CRC fails and the receiving device is not ELR capable, the receiving device may perform a receive terminating procedure 1000, such as at 1010 of the receive terminating procedure 1000, as described with reference to FIG. 10.

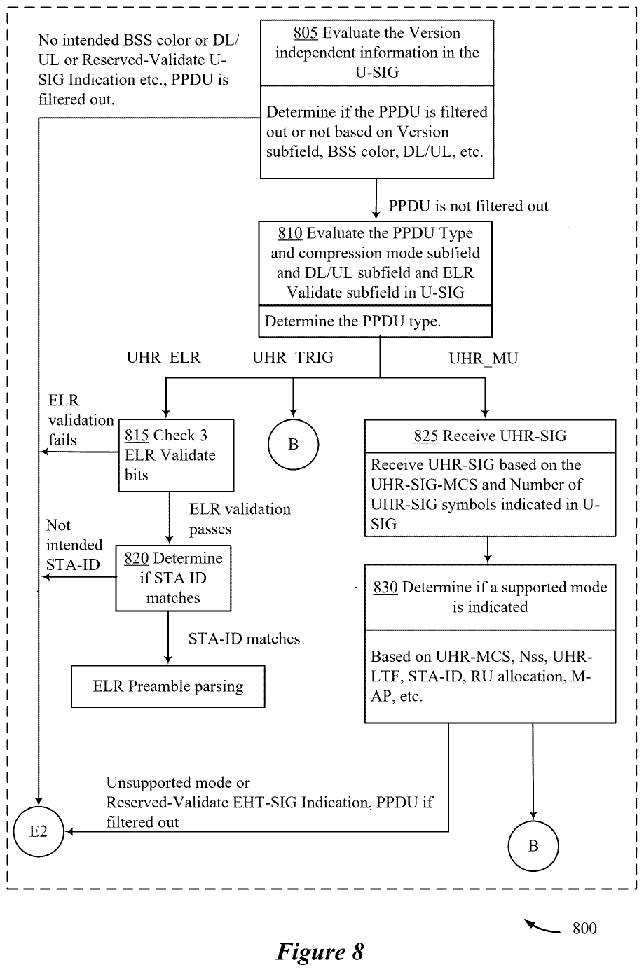

If the CRC of the U-SIG field passes, the receiving device may check a PHY version identifier at 615. If the PHY version identifier is set to 0, the receiving device may perform parsing PPDU processing procedure, such as for an EHT PPDU. For example, if the PHY version identifier is set to 0, the PHY entity of the receiving device may detect the received signal using an EHT receive procedure. If the PHY version identifier is set to 1, the receiving device may perform a UHR preamble parsing procedure 800 as described with reference to FIG. 8. For example, if the PHY version identifier=1, the PHY entity of the receiving device may continue with the UHR preamble processing. If the PHY version identifier is set to another value, the receiving device may perform the receive terminating procedure 1000.

In some examples, the LENGTH parameter modulo 3 may not be equal to zero. The receiving device may issue PHY-RXEARLYSIG.indication. At 620, the receiving device may process a HE preamble. For example, the receiving device may process an HE-SIG-A1 field and an HE-SIG-A2 field. If the HE-SIG-A2 field is BPSK modulated, the receiving device may check a CRC of the HE-SIG field. If the CRC passes or the receiving device is not ELR-capable, the receiving device may perform another PPDU parsing procedure, such as for an HE SU/TB/MU PPDU. If the CRC fails and the receiving device is ELR-capable, the receiving device may perform an ELR processing procedure 900 as described with reference to FIG. 9.

If the HE-SIG-A2 field is QBPSK modulated, the receiving device may process an HE ER SU preamble at 630. The receiving device may perform parallel processing of an HE-SIG field and, if ELR-capable, perform the ELR processing procedure 900 as described with reference to FIG. 9. For example, the receiving device may perform a parallel processing of the HE-SIG decoding and ELR-Mark checking procedure. In some examples, HE-SIG-A3 and HE-SIG-A4 may be at a same symbol location as the ELR-Mark. For example, the receiving device may perform parallel processing of 802.11a traffic and an ELR-Mark check or parallel processing of 802.11ax ER SU traffic and an ELR-Mark check. For example, if a PPDU is detected as 802.11a traffic or an ER SU PPDU, the receiving device may check the ELR mark when decoding a symbol at LSIG+4 location. If the receiving device detects an ELR-Mark, the receiving device may parse an ELR preamble at 635. If the receiving device does not detect the ELR-Mark, the receiving device may continue to perform a PPDU processing procedure, such as an HE ER SU PPDU processing procedure.

FIG. 7 shows an example of a data processing procedure 700 that supports UHR receive procedures. The data processing procedure 700 may be performed by a receiving device, such as a receiving device that is described to perform the format detection procedure 500 or the format detection procedure 600 as described with reference to FIGS. 5 and 6.

At 705, the receiving device may setup PSDU reception. For example, the receiving device may set N_{symbols} to N_{SYM} and set PHY_RXSTART.indication(RXVECTOR). At 710, the receiving device may receive a symbol. If the carrier is lost, the receiving device may determine the signal is not valid at 715. The receiving device may set RxEndStatus=(CarrierLost,Null) and decrement a timer at 720. For example, the receiving device may wait for an intended end of the PSDU. At the end of the wait at 725, the receiving device may check for a packet extension. If there is no packet extension, the receiving device may check for a signal extension at 750. If there is no signal extension, the receiving device, at the end of the wait at 760, the receiving device may set PHY_CCA.indication(idle) and set PHY-RXEND.indication(RxEndStatus). The receiving device may perform the format detection procedure 500 as described with reference to FIG. 5. If the signal is valid after receiving the symbol at 710, the receiving device

may decode the symbol at 730. For example, the receiving device may decode and descramble the symbol. At 735, the receiving device may decrement N_{symbol}. In some examples, the receiving device may set PHY_DATA.indication(DATA) and decrement a symbol count. In some examples, the receiving device may perform bit removing.

If N_{symbol} is greater than zero the receiving device may restart the data processing procedure 700 and setup the PSDU reception at 705. If N_{symbol} is equal to zero, the receiving device may end PSDU reception at 740. For example, the receiving device may set RxEndStatus=(NoError,RXVECTOR). At 745, the receiving device may check for a packet extension and wait for a duration of the packet extension. At 750, the receiving device may check for a signal extension. If there is a signal extension, the receiving device may wait for the duration of the signal extension. If there is no signal extension, the receiving device, at the end of the wait at 760, the receiving device may set PHY_CCA.indication(idle) and set PHY-RXEND.indication(RxEndStatus). The receiving device may perform the format detection procedure 500 as described with reference to FIG. 5. FIG. 8 shows an example of a UHR preamble parsing procedure 800 that supports UHR receive procedures. A receiving device, such as an AP 102 or a STA 104, may perform the UHR preamble parsing procedure, such as after performing the format detection procedure 600 as described with reference to FIG. 6.

At 805, the receiving device may evaluate version independent information in a U-SIG field of a PPDU. For example, the receiving device may determine if the PPDU is filtered out or not based on a version subfield, a BSS color, DL/UL, etc. If the PPDU is not filtered out, the receiving device may evaluate a PPDU type, compression mode subfield, DL/UL subfield, and ELR validate subfield in the U-SIG field at 810. For example, the receiving device may determine the PPDU type. In some examples, the PPDU may be a UHR ELR PPDU. At 815, the receiving device may check ELR validate bits at 815. In some examples, the ELR validation may fail, and the receiving device may perform a receive terminating procedure 1000 as described with reference to FIG. 10. If the ELR validation passes, the receiving device may determine if an identifier of the PPDU matches an identifier of the receiving device (such as, a STA identifier of the PPDU matches a STA identifier of the receiving device). In some examples, the receiving device may not be the intended receiving device, and the receiving device may perform a receive terminating procedure 1000. If the STA identifier matches, or the receiving device is the intended receiving device, the receiving device may perform ELR preamble parsing.

For example, if the U-SIG field indicates a received PPDU is a UHR ELR PPDU, all three ELR validate bits are set to one, and STA-ID value matches the 11 least significant bits of the AID of the receiving device (such as, the receiving STA), the PHY entity of the receiving device may continue receiving the UHR-STF and UHR-LTF and ELR-SIG for a UHR ELR PPDU. If CRC fails in receiving L-SIG, HT-SIG, VHT-SIG, HE-SIG, or U-SIG in other non-ELR PPDU modes, or during receiving non-HT PPDU or HE ER SU PPDU, the PHY entity of the receiving device may check for the ELR mark for a UHR ELR PPDU. The PHY entity may detect the ELR mark using a known MARK sequence corresponding to a current BSS color of the receiving device. In some examples, if VHT-SIG, HT-SIG, HE-SI, U-SIG are decoded successfully, the receiving device may continue processing the PPDU without checking the ELR Mark. In some examples, if VHT-SIG, HT-SIG, HE-SIG, U-SIG are decoded with failure, the receiving device may check for an ELR mark if the receiving device is ELR capable. In some examples, the receiving device may check for the ELR mark if the receiving device measures low SNR. If U-SIG and HE-SIG-A CRC pass, but ELR mark detection fails, deferral may be based on L-SIG length or legacy deferral rules. If ELR-SIG is decoded successfully, deferral may be based on length in ELR-SIG. If decoding ELR-SIG fails, the receiving device may defer based on a deferring procedure for non-ELR traffic. If CRCs for L-SIG and RL-SIG fail, the receiving device may skip one or more symbols of the PPDU and check for an ELR mark.

In some examples, the receiving device may determine the PPDU is a UHR-TRIG PPDU, and the receiving device may perform a data processing procedure 700 described with reference to FIG. 7. In some examples, the receiving device may determine the PPDU is a UHR-MU PPDU, and the receiving device may receive a UHR-SIG field at 825. For example, the receiving device may receive the UHR-SIG field based on a UHR-SIG-MCS and a quantity of UHR-SIG symbols indicated in the U-SIG field. At 830, the receiving device may determine if a supported mode is indicated. For example, the receiving device may determine if a supported mode is indicated based on a UHR-MCS, an Nₛₛ, a UHR-LTF field, a STA identifier, an RU allocation, a multi-AP, and the like. If an unsupported mode is indicated, or there is a Reserved-Validate UHR-SIG indication, or if the PPDU is filtered out, the receiving device may perform the receive terminating procedure 1000. If the PPDU is not filtered out, the receiving device may perform the data processing procedure 700.

FIG. 9 shows an example of an ELR processing procedure 900 that supports ultra-high reliability extended long range receive procedures. The ELR processing procedure may be performed by a receiving device, such as an AP 102 or a STA 104 described herein. In some examples, the ELR processing procedure 900 may be performed after performing a format detection procedure 500 or a format detection procedure 600 as described with reference to FIGS. 5 and 6.

At 905, the receiving device may perform and ELR mark detection procedure. The receiving device may determine whether the PPDU is an ELR PPDU and whether the PPDU is from an in-network BSS. If the ELR mark is not detected, the receiving device may go to an earlier mode and continue. For example, the receiving device may perform the format detection procedure 500 or the format detection procedure 600.

If the receiving device detects the ELR mark, the receiving device may perform an ELR preamble parsing procedure. At 910, the receiving device may receive an ELR-SIG-1 field. The receiving device may test the CRC of the ELR-SIg-1 field. If the CRC fails, the receiving device may check if an earlier mode is HT or if the L-SIG does not pass. If the earlier mode is HT or the L-SIG does not pass, the receiving device may perform a receive terminating procedure 1000 as described with reference to FIG. 10, such as by performing 1005 of the receive terminating procedure 1000. If the earlier mode is not HT and L-SIG passes, the receiving device may perform the receive terminating procedure 1000, such as by performing 1010 of the receive terminating procedure 1000.

If the CRC of the ELR-SIG-1 passes, the receiving device may evaluate an UL/DL indication at 920. The receiving device may determine if the PPDU is filtered out. If there is not intended UL/DL, the receiving device may perform the receive terminating procedure 1000, such as by performing 1010 of the receive terminating procedure 1000. If the PPDU is not filtered out, the receiving device may receive an ELR-SIG-2 field. The receiving device may test the CRC of the ELR-SIG-2 field. If the CRC of the ELR-SIG-2 field fails, the receiving device may perform the receive terminating procedure 1000, such as by performing 1010 of the receive terminating procedure 1000. If the CRC of the ELR-SIG-2 field passes, the receiving device may evaluate a station identifier at 930 and determine if the PPDU is filtered out. If there is no intended station identifier, the receiving device may perform the receive terminating procedure 1000, such as by performing 1010 of the receive terminating procedure 1000. If the PPDU is not filtered out, the receiving device may perform the data processing procedure 700 as described with reference to FIG. 7.

FIG. 10 shows an example of a receive terminating procedure 1000 that supports UHR receive procedures. The receive terminating procedure 1000 may be performed by a receiving device, such as an AP 102 or a STA 104 described herein. The receive terminating procedure 1000 may be performed based on performing a format detection procedure 500 or a format detection procedure 600 as described with reference to FIGS. 5 and 6, a UHR preamble parsing procedure 800 as described with reference to FIG. 8, or an ELR processing procedure as described with reference to FIG. 9.

In some examples, at 1005, the receiving device may determine an end of a wait time. The receiving device may set a PHY CCA indication. The receiving device may, in some examples, enter an idle state. In some examples, the receiving device may determine an end of a wait at 1010. The receiving device may set a PHY CCA indication to idle when a predicted duration based on RXTIME has elapsed, unless the receiving device has received a CCA reset request (such as, a CCARESET.request). In some examples, the receiving device may not be able to predict the RXTIME based on a first equation, and the receiving device may set PHY_CCA.indication(IDLE) when a predicted duration based on RXTIME has elapsed.

The receiving device may perform 1005 or 1010 based on different procedures. For example, the receiving device may perform 1005 based on a parity check of an L-SIG field failing and the receiving device not being ELR-capable. In some examples, the receiving device may perform 1005 based on checking if a mode of a PPDU is HT or if an L-SIG field of a PPDU passed a CRC test, as described with reference to the ELR processing procedure 900. In some examples, the receiving device may perform 1010 based on different operations of format detection procedure 500, the format detection procedure 600, the UHR preamble parsing procedure 800, or the ELR processing procedure 900. In 1010, Eqn. 38-109 may be based on length in ELR-SIG; Eqn. 38-110 may be based on the detected PPDU structure; Eqn. 36-108 may be based on the length in L-SIG, or any combination thereof.

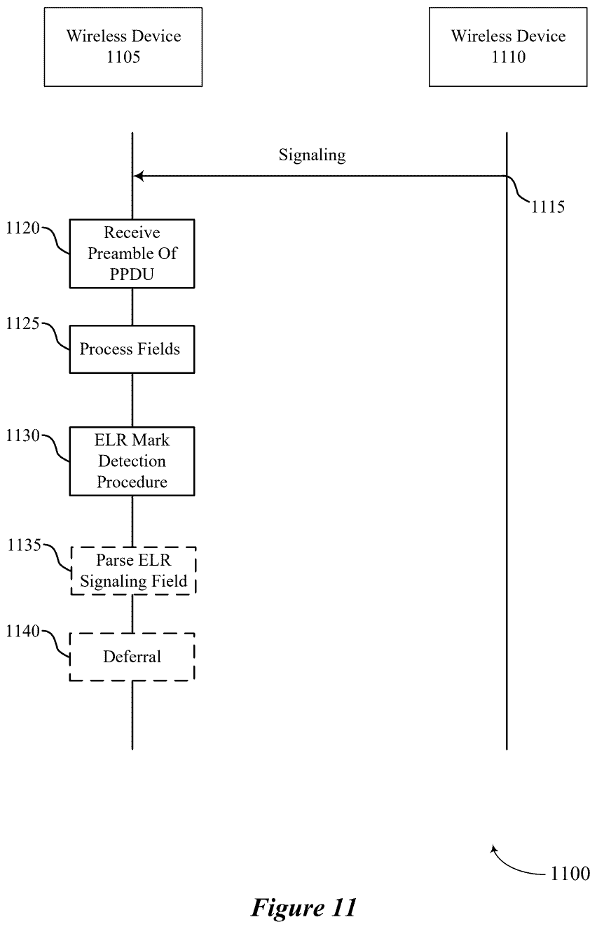

FIG. 11 shows an example of a process flow 1100 that supports ultra-high reliability extended long range receive procedures. The process flow 1100 may be implemented by a wireless device 1105 and a wireless device 1110. The wireless device 1105 and the wireless device 1110 may each be an example of an AP 102 or a STA 104 as described herein.

In some examples, alternative examples of the following may be implemented, where some operations are performed in a different order than described or are not performed at all. In some cases, operations may include additional features not mentioned below, or further operations may be added. Although the wireless device 1105 and the wireless device 1110 are shown performing the operations of the process flow 1100, some aspects of some operations may also be performed by one or more other wireless devices, network entities, or network devices.

At 1115, the wireless device 1105 may receive signaling from the wireless device 1110. At 1120, the wireless device may receive a preamble portion of a PPDU. The preamble portion of the PPDU may include a set of fields. The wireless device 1105 may be associated with a BSS and a sequence that indicates a BSS color of the BSS.

At 1125, the wireless device 1105 may process one or more fields of the set of fields of the preamble portion to determine to check whether the PPDU is associated with an ELR format. For example, the wireless device may perform a format detection procedure 500 or a format detection procedure 600, or both, as described with reference to FIGS. 5 and 6.

At 1130, the wireless device 1105 may perform an ELR mark detection procedure. For example, the wireless device 1105 may perform the ELR mark detection procedure on a candidate ELR field of the set of fields based on the sequence of the BSS color and based on a determination to check whether the PPDU is associated with the ELR format. In some examples, the wireless device 1105 may perform the ELR mark detection procedure based on an ELR processing procedure as described with reference to FIG. 9.

In some examples, at 1135, the wireless device 1105 may parse an ELR signaling field. For example, the wireless device 1105 may parse the ELR signaling field based on the ELR mark detection procedure. For example, if the wireless device detects the ELR mark based on the ELR mark detection procedure, the wireless device may parse the ELR signaling field. In some examples, the wireless device 1105 may enter another PPDU parsing mode based on the ELR mark detection procedure. For example, if the wireless device 1105 does not detect an ELR mark during the ELR mark detection procedure, the wireless device may enter the other PPDU parsing mode.

In some examples, at 1140, the wireless device may perform techniques for communications deferral. For example, if the wireless device 1105 detects a length parameter in an ELR-SIG field (such as, an ELR-length parameter), the wireless device 1105 may defer based on the ELR-length parameter. In some other examples, such as if the wireless device does not receive or detect the ELR-length parameter, the wireless device 1105 may defer based on a legacy length (L-length) parameter in an L-SIG field or a PPDU structure or PPDU mode. In some examples, if L-length and PPDU mode information are not available, the wireless device 1105 may perform another CCA check for deferral. If a PPDU is detected as a HT GF PPDU or a HT MF PPDU, the wireless device 1105 may go back to CCA check without deferral. In some examples, the wireless device 1105 may check the reliability of L-length field based on a reference signal strength indicator (RSSI) measurement or an error vector magnitude (EVM) measurement, or both.

In some examples, if a PHY entity of the wireless device 1105 is performing, in parallel, multiple receive procedures and an ELR mark is not detected, the PHY entity of the wireless device 1105 may continue with other non-ELR PPDU receive procedures. If the PHY entity of the wireless device 1105 detected CRC failure in receiving L-SIG, HT-SIG, VHT-SIG, HE-SIG, or U-SIG in other non-ELR PPDU modes, and an ELR mark is not detected, the PHY entity of the wireless device 1105 may continue with other non-ELR PPDU receive procedures to set PHY-CCA.indication(BUSY, channellist) primitive for a predicted duration of the PPDU.

If ELR-MARK is detected, or the received PPDU is a UHR ELR PPDU intended for a STA that is detected from U-SIG, the PHY entity of the wireless device 1105 may continue receiving the UHR-STF and UHR-LTF and ELR-SIG for a UHR ELR PPDU. In some examples, the PHY entity of the wireless device 1105 may check the CRCs of ELR-SIG1 and ELR-SIG2. If the CRC protecting the ELR-SIG1 field is not valid, the PHY entity of the wireless device 1105 may issue an error condition (such as, PHY-RXEND.indication(FormatViolation) primitive) and maintain PHY-CCA.indication(BUSY, channellist) primitive for a predicted duration of the transmitted PPDU derived from a LENGTH field in L-SIG if the L-SIG field passes the CRC check, unless the PHY entity of the wireless device 1105 receives a PHY-CCARESET.request primitive before the end of the PPDU, such as during spatial reuse operation. If L-SIG does not pass, the wireless device 1105 may not issue a PHY-RXEARLYSIG.indication or a PHY-RXSTART.indication primitive.

If the CRC protecting ELR-SIG1 is valid and the UL/DL does not include an intended value, the PHY entity of the wireless device 1105 shall issue a PHY-RXSTART.indication(RXVECTOR) and issue a PHY-RXEND.indication(Filtered). The PHY shall maintain a PHY-CCA.indication(BUSY, channellist) primitive for the predicted duration of the transmitted PPDU derived from the LENGTH field in ELR-SIG1, unless the wireless device 1105 receives a PHY-CCARESET.request primitive before the end of the PPDU, such as during spatial reuse operation as.

If the CRC protecting ELR-SIG1 is valid and the UL/DL contains an intended value, the PHY entity of the wireless device 1105 may check CRC of ELR-SIG2. If the CRC protecting ELR-SIG2 is not valid, the PHY may issue an error condition (such as, PHY-RXEND.indication(FormatViolation) primitive) and maintain a PHY-CCA.indication(BUSY, channellist) primitive for a predicted duration of the transmitted PPDU based on the LENGTH field in ELR-SIG1, unless the wireless device 1105 receives a PHY-CCARESET.request primitive before an end of the PPDU, such as during spatial reuse operation.

In some examples, if the CRC protecting ELR-SIG2 is valid and a STA-ID in ELR-SIG2 does not match the 11 least significant bits of the AID of a STA 104 in a BSS of the AP 102, in some examples, the PHY entity may issue PHY-RXSTART.indication(RXVECTOR), and issue a PHY-RXEND.indication(Filtered). The PHY of the wireless device 1105 may maintain PHY-CCA.indication(BUSY, channellist) primitive for a predicted duration of the transmitted PPDU derived from the LENGTH field in ELR-SIG1 unless the wireless device 1105 receives a PHY-CCARESET.request primitive. If a CRC protecting ELR-SIG2 is valid, and the STA-ID in ELR-SIG2 matches the 11 least significant bits of the AID of a STA 104 in the AP's BSS, the PHY entity of the wireless device 1105 may continue receiving the Data field of the PSDU. In some examples, in a UHR MU PPDU or a UHR TB PPDU, a data field may follow the UHR-STF field and the UHR-LTF fields. In a UHR ELR PPDU, a data field may follow the UHR-STF, UHR-LTF and ELR-SIG fields.

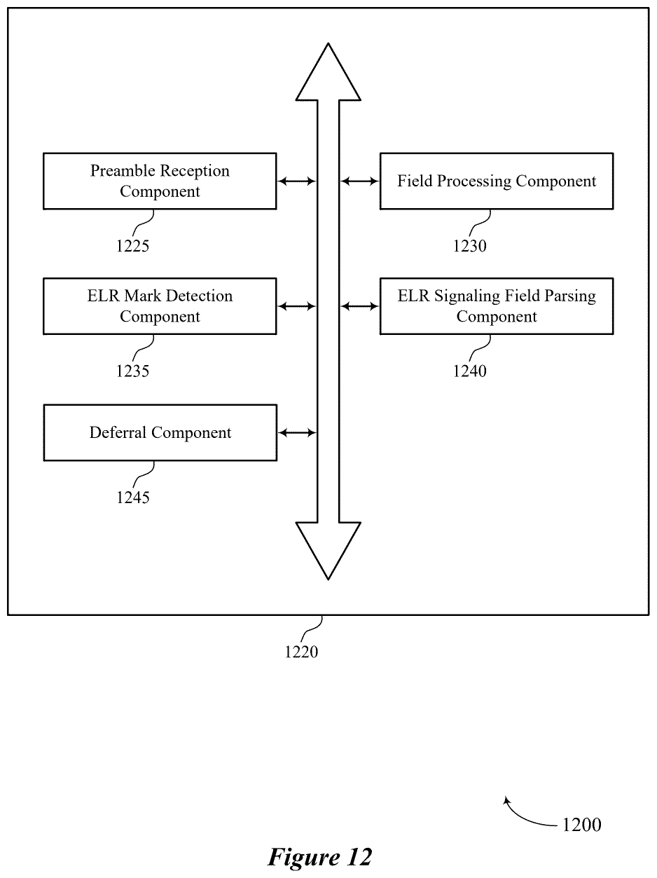

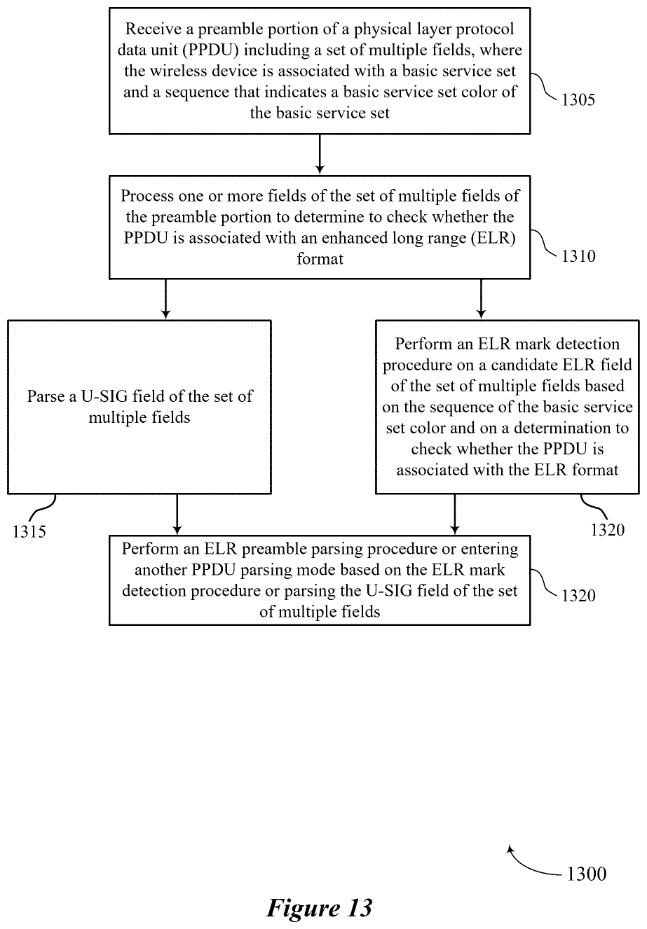

FIG. 12 shows a block diagram of an example wireless communication device 1200 that supports ultra-high reliability extended long range receive procedures. In some examples, the wireless communication device 1200 is configured to perform the process 1300 described with reference to FIG. 13. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP or STA, such as the AP 102 or the STA 104 described with reference to FIG. 1. In some other examples, the wireless communication device 1200 can be an AP or STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, that are coupled with the processing system. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes a preamble reception component 1225, a field processing component 1230, an ELR mark detection component 1235, an ELR signaling field parsing component 1240, and a deferral component 1245. Portions of one or more of the preamble reception component 1225, the field processing component 1230, the ELR mark detection component 1235, the ELR signaling field parsing component 1240, and the deferral component 1245 may be implemented at least in part in hardware or firmware. For example, one or more of the preamble reception component 1225, the field processing component 1230, the ELR mark detection component 1235, the ELR signaling field parsing component 1240, and the deferral component 1245 may be implemented at least in part by at least a processor or a modem. In some examples, portions of one or more of the preamble reception component 1225, the field processing component 1230, the ELR mark detection component 1235, the ELR signaling field parsing component 1240, and the deferral component 1245 may be implemented at least in part by a processor and software in the form of processor-executable code stored in memory.

The wireless communication device 1200 may support wireless communications in accordance with examples as disclosed herein. The preamble reception component 1225 is configurable or configured to receive a preamble portion of a physical layer protocol data unit (PPDU) including a set of multiple fields, where the wireless device is associated with a basic service set and a sequence that indicates a basic service set color of the basic service set. The field processing component 1230 is configurable or configured to process one or more fields of the set of multiple fields of the preamble portion to determine to check whether the PPDU is associated with an enhanced long range (ELR) format. The field processing component 1230 is configurable or configured to parse a universal signal (U-SIG) field of the set of multiple fields. The ELR mark detection component 1235 is configurable or configured to perform an ELR mark detection procedure on a candidate ELR field of the set of multiple fields based on the sequence of the basic service set color and on a determination to check whether the PPDU is associated with the ELR format. The ELR signaling field parsing component 1240 is configurable or configured to perform an ELR preamble parsing procedure or enter another PPDU parsing mode based on the ELR mark detection procedure or parsing the U-SIG field of the set of multiple fields, or both.

In some examples, the field processing component 1230 is configurable or configured to process the U-SIG field of the set of multiple fields that indicates that the PPDU is associated with the ELR format, where performing the ELR mark detection procedure is based on the U-SIG field that indicates the PPDU is associated with the ELR format.

In some examples, to support processing the one or more fields, the field processing component 1230 is configurable or configured to perform one or more error detection procedures for a legacy signal (L-SIG) field, a high throughput signal (HT-SIG) field, a very high throughput signal (VHT-SIG) field, a high efficiency signal (HE-SIG) field, or a universal signal (U-SIG) field, or any combination thereof, where performing the ELR mark detection procedure is based on one or more failures of the one or more error detection procedures.

In some examples, to support processing the one or more fields, the field processing component 1230 is configurable or configured to process one or more of the set of multiple fields according to a non-high throughput (non-HT) PPDU format or a high efficiency (HE) extended range (ER) single user (SU) PPDU format, or both, where performing the ELR mark detection procedure is based on processing according to the non-HT PPDU format or the HE ER SU PPDU format.

In some examples, the field processing component 1230 is configurable or configured to determine, in parallel to determining whether to perform the ELR mark detection procedure, whether the PPDU is associated with the non-HT PPDU format or the HE ER SU PPDU format.

In some examples, the ELR signaling field parsing component 1240 is configurable or configured to decode a data field of the PPDU based on parsing the ELR signaling field.

In some examples, the field processing component 1230 is configurable or configured to parse an ELR signal (ELR-SIG) field based on performing the ELR mark detection procedure. In some examples, the deferral component 1245 is configurable or configured to defer transmission based on an ELR length parameter that is indicated by the ELR-SIG field. In some examples, the deferral component 1245 is configurable or configured to defer transmission based on non-ELR processing rules based on the ELR length parameter not being successfully decoded by the ELR-SIG field.

In some examples, the ELR mark detection component 1235 is configurable or configured to measure a reference signal strength indicator (RSSI) or an error vector magnitude (EVM) associated with the PPDU, where performing the ELR mark detection procedure is based on an RSSI measurement or an EVM measurement, or both, satisfying a threshold.

In some examples, the ELR mark detection procedure is based on an ELR capability of the wireless device.

FIG. 13 shows a flowchart illustrating an example process 1300 performable by or at a wireless device that supports ultra-high reliability extended long range receive procedures. The operations of the process 1300 may be implemented by a wireless device or its components as described herein. For example, the process 1300 may be performed by a wireless communication device, such as the wireless communication device 1200 described with reference to FIG. 12, operating as or within a wireless AP or a wireless STA. In some examples, the process 1300 may be performed by a wireless AP or a wireless STA, such as one of the APs 102 or the STAs 104 described with reference to FIG. 1.

In some examples, in 1305, the wireless device may receive a preamble portion of a physical layer protocol data unit (PPDU) including a set of multiple fields, where the wireless device is associated with a basic service set and a sequence that indicates a basic service set color of the basic service set. The operations of 1305 may be performed in accordance with examples as disclosed herein. In some implementations, aspects of the operations of 1305 may be performed by a preamble reception component 1225 as described with reference to FIG. 12.

In some examples, in 1310, the wireless device may process one or more fields of the set of multiple fields of the preamble portion to determine to check whether the PPDU is associated with an enhanced long range (ELR) format. The operations of 1310 may be performed in accordance with examples as disclosed herein. In some implementations, aspects of the operations of 1310 may be performed by a field processing component 1230 as described with reference to FIG. 12.

In some examples, in 1315, the wireless device may parse a U-SIG field of the set of multiple fields. The operations of 1315 may be performed in accordance with examples as disclosed herein. In some implementations, aspects of the operations of 1315 may be performed by a field processing component 1230 as described with reference to FIG. 12.

In some examples, in 1320, the wireless device may perform an ELR mark detection procedure on a candidate ELR field of the set of multiple fields based on the sequence of the basic service set color and on a determination to check whether the PPDU is associated with the ELR format. The operations of 1320 may be performed in accordance with examples as disclosed herein. In some implementations, aspects of the operations of 1320 may be performed by an ELR mark detection component 1235 as described with reference to FIG. 12.

In some examples, in 1325, the wireless device may parse an ELR signaling field or entering another PPDU parsing mode based on the ELR mark detection procedure. The operations of 1325 may be performed in accordance with examples as disclosed herein. In some implementations, aspects of the operations of 1320 may be performed by an ELR signaling field parsing component 1240 as described with reference to FIG. 12.

Implementation examples are described in the following numbered clauses:

Aspect 1: A method for wireless communications at a wireless device, comprising: receiving a preamble portion of a physical layer protocol data unit (PPDU) comprising a plurality of fields, wherein the wireless device is associated with a basic service set and a sequence that indicates a basic service set color of the basic service set; processing one or more fields of the plurality of fields of the preamble portion to determine to check whether the PPDU is associated with an enhanced long range (ELR) format; parsing a universal signal (U-SIG) field of the plurality of fields; or performing an ELR mark detection procedure on a candidate ELR field of the plurality of fields based at least in part on the sequence of the basic service set color and on a determination to check whether the PPDU is associated with the ELR format; and performing an ELR preamble parsing procedure or entering another PPDU parsing mode based at least in part on the ELR mark detection procedure or parsing the U-SIG field of the plurality of fields, or both.

Aspect 2: The method of aspect 1, further comprising: processing the U-SIG field that indicates that the PPDU is associated with the ELR format, wherein performing the ELR preamble parsing procedure is based at least in part on the U-SIG subfield that indicates the PPDU is associated with the ELR format.

Aspect 3: The method of any of aspects 1 through 2, wherein processing the one or more fields comprises: performing one or more error detection procedures for a legacy signal (L-SIG) field, a high throughput signal (HT-SIG) field, a very high throughput signal (VHT-SIG) field, a high efficiency signal (HE-SIG) field, or the U-SIG field, or any combination thereof, wherein performing the ELR mark detection procedure is based at least in part on one or more failures of the one or more error detection procedures.

Aspect 4: The method of any of aspects 1 through 3, wherein processing the one or more fields comprises: processing one or more of the plurality of fields according to a non-high throughput (non-HT) PPDU format or a high efficiency (HE) extended range (ER) single user (SU) PPDU format, or both, wherein performing the ELR mark detection procedure is based at least in part on processing according to the non-HT PPDU format or the HE ER SU PPDU format.

Aspect 5: The method of aspect 4, further comprising: determining, in parallel to determining whether to perform the ELR mark detection procedure, whether the PPDU is associated with the non-HT PPDU format or the HE ER SU PPDU format.

Aspect 6: The method of any of aspects 1 through 5, further comprising: decoding a data field of the PPDU based at least in part on parsing the ELR signaling field.

Aspect 7: The method of any of aspects 1 through 6, further comprising: parsing an ELR signal (ELR-SIG) field based at least in part on performing the ELR mark detection procedure.

Aspect 8: The method of aspect 7, further comprising: deferring transmission based at least in part on an ELR length parameter that is indicated by the ELR-SIG field; or deferring transmission based at least in part on non-ELR processing rules based at least in part on the ELR length parameter not being successfully decoded by the ELR-SIG field.

Aspect 9: The method of any of aspects 1 through 8, further comprising: measuring a reference signal strength indicator (RSSI) or an error vector magnitude (EVM) associated with the PPDU, wherein performing the ELR mark detection procedure is based at least in part on an RSSI measurement or an EVM measurement, or both, satisfying a threshold.

Aspect 10: The method of any of aspects 1 through 9, wherein the ELR mark detection procedure is based at least in part on an ELR capability of the wireless device.

Aspect 11: A wireless device for wireless communications, comprising one or more memories storing processor-executable code, and one or more processors coupled with the one or more memories and individually or collectively operable to execute the code to cause the wireless device to perform a method of any of aspects 1 through 10.

Aspect 12: A wireless device for wireless communications, comprising at least one means for performing a method of any of aspects 1 through 10.

Aspect 13: A non-transitory computer-readable medium storing code for wireless communications, the code comprising instructions executable by one or more processors to perform a method of any of aspects 1 through 10.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
receive a preamble portion of a physical layer protocol data unit (PPDU) comprising a plurality of fields, wherein the wireless device is associated with a basic service set and a sequence that indicates a basic service set color of the basic service set;
process one or more fields of the plurality of fields of the preamble portion to determine to check whether the PPDU is associated with an enhanced long range (ELR) format;
parse a universal signal (U-SIG) field of the plurality of fields; or
perform an ELR mark detection procedure on a candidate ELR field of the plurality of fields based at least in part on the sequence of the basic service set color and on a determination to check whether the PPDU is associated with the ELR format; and
perform an ELR preamble parsing procedure or enter another PPDU parsing mode based at least in part on the ELR mark detection procedure or the U-SIG field of the plurality of fields being parsed, or both.

2. The wireless device of claim 1, wherein the processing system is further configured to cause the wireless device to:
process the U-SIG field that indicates that the PPDU is associated with the ELR format, wherein the ELR preamble parsing procedure is performed based at least in part on the U-SIG field that indicates the PPDU is associated with the ELR format.

3. The wireless device of claim 1, wherein, to process the one or more fields, the processing system is configured to cause the wireless device to:
perform one or more error detection procedures for a legacy signal (L-SIG) field, a high throughput signal (HT-SIG) field, a very high throughput signal (VHT-SIG) field, a high efficiency signal (HE-SIG) field, or the U-SIG field, or any combination thereof, wherein the ELR mark detection procedure is performed based at least in part on one or more failures of the one or more error detection procedures.

4. The wireless device of claim 1, wherein, to process the one or more fields, the processing system is configured to cause the wireless device to:
process one or more of the plurality of fields according to a non-high throughput (non-HT) PPDU format or a high efficiency (HE) extended range (ER) single user (SU) PPDU format, or both, wherein the ELR mark detection procedure is performed based at least in part on processing according to the non-HT PPDU format or the HE ER SU PPDU format.

5. The wireless device of claim 4, wherein the processing system is further configured to cause the wireless device to:
determine, in parallel to determining whether to perform the ELR mark detection procedure, whether the PPDU is associated with the non-HT PPDU format or the HE ER SU PPDU format.

6. The wireless device of claim 1, wherein the processing system is further configured to cause the wireless device to:
decode a data field of the PPDU based at least in part on an ELR signaling field being parsed.

7. The wireless device of claim 1, wherein the processing system is further configured to cause the wireless device to:
parse an ELR signal (ELR-SIG) field based at least in part on performance of the ELR mark detection procedure.

8. The wireless device of claim 7, wherein the processing system is further configured to cause the wireless device to:
defer transmission based at least in part on an ELR length parameter that is indicated by the ELR-SIG field; or
defer transmission based at least in part on non-ELR processing rules based at least in part on the ELR length parameter not being successfully decoded by the ELR-SIG field.

9. The wireless device of claim 1, wherein the processing system is further configured to cause the wireless device to:
measure a reference signal strength indicator (RSSI) or an error vector magnitude (EVM) associated with the PPDU, wherein the ELR mark detection procedure is performed based at least in part on an RSSI measurement or an EVM measurement, or both, satisfying a threshold.

10. The wireless device of claim 1, wherein the ELR mark detection procedure is based at least in part on an ELR capability of the wireless device.

11. A method for wireless communications at a wireless device, comprising:
receiving a preamble portion of a physical layer protocol data unit (PPDU) comprising a plurality of fields, wherein the wireless device is associated with a basic service set and a sequence that indicates a basic service set color of the basic service set;
processing one or more fields of the plurality of fields of the preamble portion to determine to check whether the PPDU is associated with an enhanced long range (ELR) format;
parsing a universal signal (U-SIG) field of the plurality of fields; or
performing an ELR mark detection procedure on a candidate ELR field of the plurality of fields based at least in part on the sequence of the basic service set color and on a determination to check whether the PPDU is associated with the ELR format; and
perform an ELR preamble parsing procedure or entering another PPDU parsing mode based at least in part on the ELR mark detection procedure or parsing the U-SIG field of the plurality of fields, or both.

12. The method of claim 11, further comprising:
processing the U-SIG field that indicates that the PPDU is associated with the ELR format, wherein the ELR preamble parsing procedure is based at least in part on the U-SIG field that indicates the PPDU is associated with the ELR format.

13. The method of claim 11, wherein processing the one or more fields comprises:
performing one or more error detection procedures for a legacy signal (L-SIG) field, a high throughput signal (HT-SIG) field, a very high throughput signal (VHT-SIG) field, a high efficiency signal (HE-SIG) field, or a universal signal (U-SIG) field, or any combination thereof, wherein performing the ELR mark detection procedure is based at least in part on one or more failures of the one or more error detection procedures.

14. The method of claim 11, wherein processing the one or more fields comprises:
processing one or more of the plurality of fields according to a non-high throughput (non-HT) PPDU format or a high efficiency (HE) extended range (ER) single user (SU) PPDU format, or both, wherein performing the ELR mark detection procedure is based at least in part on processing according to the non-HT PPDU format or the HE ER SU PPDU format.

15. The method of claim 14, further comprising:
determining, in parallel to determining whether to perform the ELR mark detection procedure, whether the PPDU is associated with the non-HT PPDU format or the HE ER SU PPDU format.

16. The method of claim 11, further comprising:
decoding a data field of the PPDU based at least in part on parsing an ELR signaling field.

17. The method of claim 11, further comprising:
measuring a reference signal strength indicator (RSSI) or an error vector magnitude (EVM) associated with the PPDU, wherein performing the ELR mark detection procedure is based at least in part on an RSSI measurement or an EVM measurement, or both, satisfying a threshold.

18. The method of claim 11, wherein the ELR mark detection procedure is based at least in part on an ELR capability of the wireless device.

19. A non-transitory computer-readable medium storing code for wireless communications by a wireless device, the code comprising instructions executable by one or more processors to:
receive a preamble portion of a physical layer protocol data unit (PPDU) comprising a plurality of fields, wherein the wireless device is associated with a basic service set and a sequence that indicates a basic service set color of the basic service set;
process one or more fields of the plurality of fields of the preamble portion to determine to check whether the PPDU is associated with an enhanced long range (ELR) format;
parse a universal signal (U-SIG) field of the plurality of fields; or
perform an ELR mark detection procedure on a candidate ELR field of the plurality of fields based at least in part on the sequence of the basic service set color and on a determination to check whether the PPDU is associated with the ELR format; and
perform an ELR preamble parsing procedure or enter another PPDU parsing mode based at least in part on the ELR mark detection procedure or parsing the U-SIG field of the plurality of fields, or both.

20. The non-transitory computer-readable medium of claim 19, wherein the instructions are further executable by the one or more processors to:
process the U-SIG field that indicates that the PPDU is associated with the ELR format, wherein the ELR preamble parsing procedure is performed based at least in part on the U-SIG field that indicates the PPDU is associated with the ELR format.
